(19) United States
(12) Patent Application Publication
(10) Pub. No.: US 2015/0085612 A1
(43) Pub. Date: Mar. 26, 2015

(54) METHOD AND DRIVING-ENVIRONMENT SENSOR FOR DETERMINING THE POSITION AND/OR THE MOVEMENT OF AT LEAST ONE OBJECT IN THE VICINITY OF A VEHICLE ON THE BASIS OF ACOUSTIC SIGNALS REFLECTED OFF OF THE OBJECT

(71) Applicant: Matthias Karl, Ettlingen (DE)

(72) Inventor: Matthias Karl, Ettlingen (DE)

(21) Appl. No.: 14/372,437

(22) PCT Filed: Dec. 7, 2012
(86) PCT No.: PCT/EP2012/074819

§ 371 Date: Jul. 15, 2014

(30) Foreign Application Priority Data
Jan. 19, 2012 (DE) 10 2012 200 729.6

(51) Int. Cl. G01S 7/529

(52) U.S. Cl. CPC G01S 7/529
USPC 367/98

(57) ABSTRACT

In a method for determining the position and/or the movement of an object in the vicinity of a vehicle, received echo signals that have been reflected off of the object are each amplified by an amplification that is dependent on the propagation delay of the corresponding echo signal, and amplified echo signals of a plurality of measuring channels are each converted into a value-discretized and/or time-discretized measurement signal having a predefined, first dynamic range; and the measurement signals, which each have the first dynamic range, are mapped onto a second dynamic range of a processing device that is larger than the first dynamic range, in a way that allows them to be at least periodically simultaneously processed by the processing device.

### BACKGROUND OF THE INVENTION

1. Field of the Invention

The present invention relates to a method and a driving-environment sensor for determining the position and/or the movement of at least one object in the vicinity of a vehicle, on the basis of received signals that have been reflected off of the object, which are referred to as echo signals.

2. Description of the Related Art

To acoustically sense the driving environment of vehicles, systems operating in the ultrasound range, in particular systems which measure in pulsed operation, are typically used at the present time. Acoustic pulses are emitted at approximately 50 kHz every 10 to 300 ms via an electroacoustic transducer. The object's distance in space is deduced from the pulse propagation time of the transmitting and non-transmitting transducers. Measurements verify what is known from the technical literature, i.e., that the signal strength decreases with increasing echo delay time. This is also clearly shown in FIG. 1.

In FIG. 1, echo amplitude EA of acoustic echo signals, which represent acoustic signals that have been reflected off of various objects 01, 02, 03, 04, 05, 06, 07, 08, 09, 010, are depicted as a function of object distance d.

Echo amplitude EA is indicated in millivolts and the object distance in meters.

Objects 01 through 04 are walls and are depicted as crosses; objects 05 through 08 are pipes and are depicted as circles; and objects 09 and 010 are vehicles (BMW3) and are depicted as squares. All of objects 01 through 010 are detected in each case by acoustic transmission pulses having a respective transmission pulse duration of 12 ms, 6 ms, 1 ms, 0.3 ms, 12 ms, 6 ms, 1 ms, 0.3 ms, 6 ms and 1 ms. The indicated transmission pulse durations are negligible for the dependence of the echo signal strength on the echo delay time.

Grid lines 1 are also sketched in to simplify the understanding of FIG. 1.

A high amplitude range of 1 mV to 2000 mV, for example, which corresponds to a dynamic range of 2¹¹, must be used to resolve all possible echo signal strengths. If the intention is to detect the signal reflected off of a pipe 05, 06, 07, 08, for example, that oscillates both positively, as well as negatively relative to a mean value, a dynamic range of 2¹² and, therefore, also the use of a complex 12-bit transducer, respectively of a comparably low-noise signal processing technology, is required. Along with the signal dynamics used, the corresponding processing outlay, such as the computational outlay, for example, also increases.

From the related art, it is also generally known that digital computation cores available today mostly have a 16-bit dynamic range. Moreover, the magnitude of the computing capacity is defined here as C=f·n, n standing for the dynamic range and f for the processing frequency of a signal processing device.

From the German Patent Application DE 10 2008 054 789 A1, it is also known for a driving-environment sensor system, which measures in pulsed operation, to use a propagation delay-dependent amplification of the received echo signals.

The same document also describes that, in addition, when the dynamics of the propagation delay-dependent amplification does not suffice for compressing both low-level, as well as high-level signals to the transmission length, an amplitude compression of the echo signal may follow in order to process signal strengths that are too high for a further transmission. Moreover, it is known to one skilled in the art that an equivalent application of this method is also possible for driving-environment sensor systems that measure in pulsed operation using signal frequencies outside of the ultrasonic range, such as the range audible to the human ear, for example.

It is also generally known from the related art how information can be obtained about the characteristic of a propagation delay-dependent attenuation of a transmission channel.

### BRIEF SUMMARY OF THE INVENTION

The present invention provides a method for determining the position and/or the movement of an object in the vicinity of a transport means, in particular a vehicle, on the basis of received signals that have been reflected off of the object. These are referred to in the following as echo signals. The received echo signals are each amplified by an amplification that is dependent on the propagation delay of the corresponding echo signal, and amplified echo signals of a plurality of measuring channels are each converted into a value-discretized and/or time-discretized measurement signal having a predefined, first dynamic range (m). In addition, the measurement signals, which each have first dynamic range (m), are mapped onto a second dynamic range of a processing device that is larger than the first dynamic range, in a way that allows them to be at least periodically simultaneously processed by the processing device.

The present invention also provides a driving-environment sensor for determining the position and/or the movement of at least one object in the vicinity of a transport means, in particular a vehicle, on the basis of received signals that have been reflected off of the object. In the following, these are referred to as echo signals. The driving-environment sensor includes one or a plurality of amplifiers, which are each designed to amplify the received echo signals, in each case by an amplification that is dependent on the propagation delay of the corresponding echo signal. In addition, the driving-environment sensor is designed for converting amplified echo signals of a plurality of measuring channels, in particular by at least one threshold switch and/or at least one analog-digital converter, into a respective value-discretized and/or time-discretized measurement signal having a predefined, first dynamic range (m), and for at least periodically simultaneously processing the measurement signals, which each have the first dynamic range, by a processing device having a second dynamic range that is larger than the first dynamic range.

In the method according to the present invention, in particular, following the emission of a measurement pulse, the amplification of the received signals is continuously or quasi-continuously varied, at least periodically. In other words, the received echo signals are amplified by a propagation delay-dependent amplification. The amplified echo signals are converted in each case by a threshold switch, in particular, into a continuous-time, discrete-value signal that, in addition to the value discretization, is also subject to a time discretization, preferably by sampling performed by an A/D converter. The discretized signal has dynamic range m, and the signals of a plurality of measuring channels are processed in parallel using a processing technology that includes a larger dynamic range n than dynamic range m of a measurement signal.

In other words, an architecture is provided in accordance with the present invention that, in particular, makes it possible to efficiently process the signals of the pulsed-operated, acoustic driving-environment sensor system.

The parallelization advantageously allows a plurality of signals to be processed simultaneously in one operation.

The present invention also provides for a warning to be output to the driver, preferably in response to the presence of a collision danger between the transport means, in particular one's own vehicle, and the object, as ascertained by at least one measurement signal; and/or for an intervention to be made into the transport means dynamics, in particular the vehicle dynamics; and/or for at least one means to be activated for diminishing the aftermath of an accident.

In accordance with the present invention, the position and/or the movement of objects in the vicinity of transport means, such as mobility scooters, segways, bicycles, electric-powered cars, other vehicles, such as automobiles, buses and trucks, are/is determined by ultrasound signals emitted in a pulse shape. In the process, the operator of the transport means is informed via optical and/or acoustic means about the distance, the position, and/or the direction of movement of the objects located in the vicinity of the transport means. In addition, the directions of movement may be changed by steering and/or the velocity by braking. Means for diminishing the aftermath of an accident, such as seat-belt tensioners and/or power windows and/or airbags and/or means for raising the engine hood may be activated.

One especially advantageous specific embodiment of the present invention provides for first dynamic range m to be varied as a function of the situation, i.e., as a function of an existing ambient situation and/or driving situation.

For example, if an especially critical situation is suspected in one sensor's direction of observation, resolution m is increased there, while resolution m₂ for a sensor, in whose direction of observation fewer important events are suspected, is simultaneously decreased.

Another example of this is that the sampling frequency, which corresponds to the frequency at which a modified value may occur, is varied. The vehicle's own velocity and/or the recognized relative velocity to an object and/or the object distance and/or the type of object, which may be a flat wall or shrubbery, for example, may be a manipulated variable for the modification.

One especially advantageous specific embodiment of the present invention provides that the time characteristic of the propagation delay-dependent amplification be adjusted by a control. The time characteristic of the propagation delay-dependent amplification may also be adjusted in a way that allows a calibration curve, which estimates an amplitude characteristic of suitable calibration echo signals, to be mapped by the propagation delay-dependent amplification onto a time-invariant straightline, which corresponds to a constant signal strength value. This greatly simplifies the evaluation of echo signals that have been amplified by such a propagation delay-dependent amplification.

The time characteristic of the propagation delay-dependent amplification is preferably adjusted as a function of an existing ambient situation and/or driving situation and/or as a function of a function state, in particular a contamination state, of at least one receiving electroacoustic transducer.

In other words, the time characteristic of the propagation delay-dependent amplification is adapted to an ambient situation, respectively to a transducer state, in particular to a transducer contamination state, by a customary, readily realized channel estimation.

In addition, a vehicle having a driving-environment sensor according to the present invention is provided in accordance with the present invention.

### BRIEF DESCRIPTION OF THE DRAWINGS

FIG. 1 shows the characteristic curve of the amplitude of the echo amplitudes originating from the reflections of acoustic signals off of a plurality of partially distinct objects as a function of the object distance in accordance with the related art.

FIG. 2 shows the characteristic curve of calibration curves, which are illustrated as a function of the object distance which each estimate an amplitude characteristic of calibration echo signals, and the characteristic curve of the calibration curves acted upon by an inventive, propagation delay-dependent amplification, illustrated as a function of the object distance, which, in addition to the characteristic curve of the echo amplitudes from FIG. 1 that is dependent on the object distance, have been shown.

FIG. 3 schematically represents the allocation of five measuring channels, each having a dynamic range of six bits, to a processing width of 32 bits.

FIG. 4 is a schematic block diagram of a driving environment sensor according to the present invention in accordance with a first specific embodiment of the present invention.

### DETAILED DESCRIPTION OF THE INVENTION

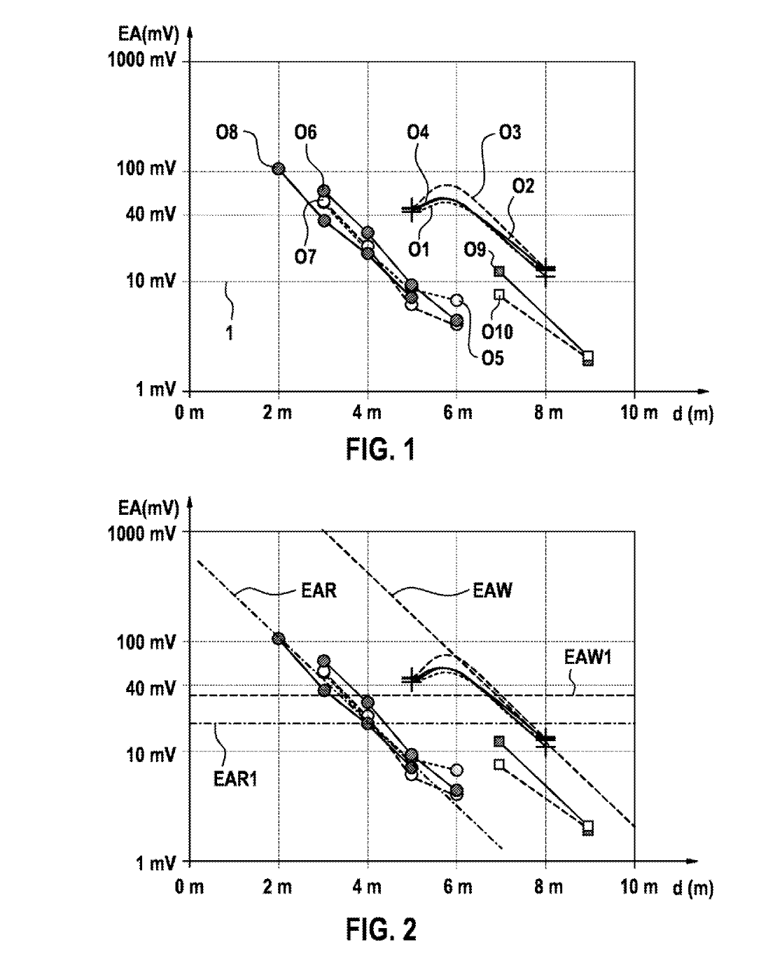

In FIG. 2, echo amplitude EA of the same acoustic echo signals as those in accordance with FIG. 1, which represent the acoustic signals that have been reflected off of objects 01, 02, 03, 04, 05, 06, 07, 08, 09, 010, is depicted as a function of object distance d. Echo amplitude EA is indicated in millivolts and object distance d in meters. To simplify the illustration, objects 01 through 010 are no longer explicitly characterized.

The characteristic of two calibration curves EAW and EAR, which each estimate an amplitude characteristic of calibration echo signals, is also depicted in FIG. 2 as a function of the object distance. In this case, both calibration curves EAW and EAR are linear.

Dash-dash line EAW is used for the calibration line that estimates the amplitude characteristic of calibration echo signals that originate from reflections at walls 01 through 04. In addition, dash-dot line EAR is used for the calibration line that estimates the amplitude characteristic of calibration echo signals that originate from reflections at pipes 05 through 08.

The mode of action of the propagation delay-dependent amplification becomes clear when lines EAW and EAR entered in FIG. 2 are used as a reference.

Calibration curves EAW, respectively EAR are illustrated for a variation of object distance d over the entire value range thereof. In practice, these characteristics of lines EAW, EAR, which are dependent on d, are not straight lines, but rather more complex, even when object distance d is varied along the axis of the receiving sensors. However, once the characteristic curve is known, this phenomenon does not play any role in the parallel processing principle. It is generally known from the literature that the characteristic curve of such lines EAW, EAR is dependent on the climate, such as air humidity, temperature and barometric air pressure. Therefore, if climate information, such as air humidity information is missing, for example, estimators are used.

The present invention provides that the time characteristic of the propagation delay-dependent amplification be adjusted in a particular measuring cycle in a way that allows calibration curves EAW, EAR, which each estimate an amplitude characteristic of suitable calibration echo signals in a corresponding measuring cycle, to each be mapped via the appropriate propagation delay-dependent amplification onto a corresponding straight line EAW1, EAR1 that is independent of object distance d and corresponds to a constant signal strength value. Lines EAW1 and EAR1 extend as straight lines in parallel to abscissa d, thereby greatly simplifying the evaluation of echo signals that have been amplified by such a propagation delay-dependent amplification.

On the basis of the relationships between lines EAW and EAR illustrated in FIG. 2, it is possible to ascertain that the echo signal strength of the most highly reflecting objects, which are walls 01 through 04, and the echo signal strength of the rather less highly reflecting objects, which are pipes 05 through 08, differ dynamically only by the factor of about 26, i.e., by less than 2⁵. For example, if, as a precaution, the amplitude resolution is increased by a further two bits, and another bit is used for displaying the operational sign, then a resolution of eight bits and less suffices when the propagation delay-dependent amplification according to the present invention, via which a constant signal strength of the amplified echo signals is achieved, is optimally adapted to the propagation situation.

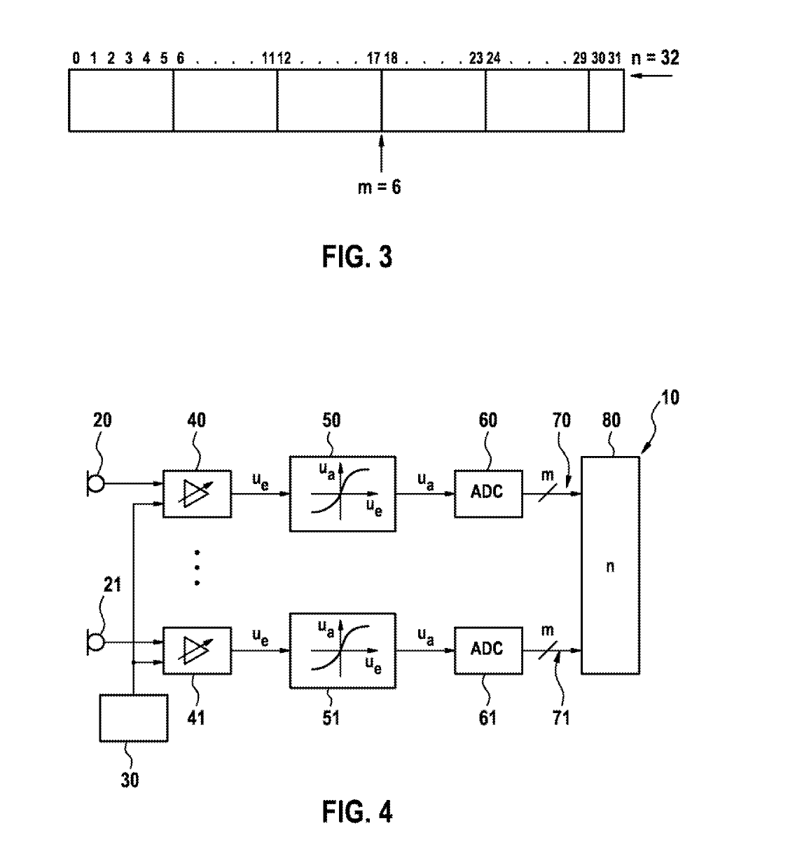

Since, in the case of the driving environment detection, the signals from a plurality of sensors are to be analyzed simultaneously, respectively quasi-simultaneously, and the computation width typical today of digital signal-processing devices is mostly 16 bits and more, the signals from a plurality of sensor channels may be processed in parallel when the individual channels are mapped onto the width of computing device n. FIG. 3 schematically represents the allocation of five measuring channels, each having a dynamic range of six bits, to a processing width of 32 bits.

Numbers 0, . . . , 31 of the 32 digit positions are illustrated at the top in FIG. 3. In the case of a dynamic range of m=6 bits, each channel requires six digit positions. In the example illustrated in FIG. 3, two digit positions are free in each case.

The advantage of the parallelization is that a plurality of signals are processed simultaneously in one operation. Since many processors very readily permit a differentiation of the data by bytes, an allocation of m=8 bit positions each per channel is particularly suited.

In many known evaluations, the parallelization renders possible an efficient processing. In the case of such a type of evaluation, a great number of additions and subtractions is possible. If, in the design of the computational operations, it is noted that carriers or crosstalk do not arise among the channels, in the example illustrated in FIG. 3, the value of five channels may be simultaneously evaluated in one operational step of the variable that is n positions wide.

In combination with the amplitude-compressing amplifiers, the signal dynamic required per channel may be reduced to four bits, inclusive of the operational sign.

A schematic block diagram of a driving environment sensor 10 according to the present invention is illustrated in FIG. 4 in accordance with a first specific embodiment of the present invention.

Receiving electroacoustic transducers 20, 21, inclusive of the required adaptation and/or filtering and/or preamplification, are illustrated schematically in FIG. 4 as microphone symbols. They are followed by amplifiers 40, 41, featuring an adjustable gain, that may be synchronized to the transmission instant by the SYNC signal generated by device 30. They are followed by amplifiers 50, 51, each having a non-linear characteristic uₐ(uₑ), that are designed for amplifying loud signals to a lesser extent than soft signals. A value discretization and, in this case, due to the use of analog-to-digital converter 60, 61, also a time discretization subsequently take place. Individual channels 70, 71 are finally parallelized to allow more rapid further processing in at least one subsequent processing unit having a dynamic range of n bits in accordance with the fundamental idea underlying the present invention.

In addition to the disclosure written above, reference is also hereby made to the illustration in FIG. 1 through 4 for the further disclosure of the present invention.

1-9. (canceled)

10. A method for determining at least one of a position and a movement of an object in the vicinity of a vehicle, comprising:
receiving echo signals which represent acoustic detection signals reflected off of the object;
amplifying each of the received echo signals by an amplification which is dependent on the propagation delay of the respective echo signal;
converting each of the amplified echo signals of a plurality of measuring channels into at least one of a value-discretized and time-discretized measurement signal having a predefined, first dynamic range; and
mapping each of the measurement signals which have the first dynamic range onto a second dynamic range of a processing device, the second dynamic range being larger than the first dynamic range, whereby the processing device simultaneously processes the measurement signals at least periodically.

11. The method as recited in claim 10, wherein the first dynamic range is selected as a function of at least one of an ambient situation and a driving situation.

12. The method as recited in claim 11, wherein at least one of:
the time characteristic of the propagation delay-dependent amplification is adjusted by a control;
the time characteristic of the propagation delay-dependent amplification is adjusted in a way which allows a calibration curve, which estimates an amplitude characteristic of selected calibration echo signals, to be mapped by the propagation delay-dependent amplification onto a time-invariant straight-line, which corresponds to a constant signal strength value; and
the time characteristic of the propagation delay-dependent amplification is adjusted as a function of at least one of an ambient situation, a driving situation, and a contamination state of at least one receiving electroacoustic transducer.

13. The method as recited in claim 12, further comprising at least one of:
(i) outputting a warning to the driver in the case a presence of a collision danger between the vehicle and the object is ascertained based on at least one of the measurement signals;
(ii) intervening in the vehicle dynamics; and
(iii) activating at least one passenger safety mechanism of the vehicle.

14. A driving environment sensor for determining at least one of a position and a movement of an object in the vicinity of a vehicle based on received echo signals which represent acoustic detection signals reflected off of the object, comprising:
amplifying, by at least one amplifier, each of the received echo signals by an amplification which is dependent on the propagation delay of the respective echo signal;
converting, by at least one of a threshold switch and an analog-digital converter, each of the amplified echo signals of a plurality of measuring channels into at least one of a value-discretized and time-discretized measurement signal having a predefined, first dynamic range; and
a processing device which (i) maps each of the measurement signals which have the first dynamic range onto a second dynamic range of a processing device, the second dynamic range being larger than the first dynamic range, and (ii) simultaneously processes the measurement signals at least periodically.

15. The driving environment sensor as recited in claim 14, wherein the driving environment sensor specifies the first dynamic range as a function of at least one of an ambient situation and a driving situation.

16. The driving environment sensor as recited in claim 15, wherein the at least one amplifier includes a control device which at least one of:
(i) adjusts the time characteristic of the propagation delay-dependent amplification by a control;
(ii) adjusts the time characteristic of the propagation delay-dependent amplification in a way which allows a calibration curve, which estimates an amplitude characteristic of selected calibration echo signals, to be mapped by the propagation delay-dependent amplification onto a time-invariant straight-line, which corresponds to a constant signal strength value; and
(iii) adjusts the time characteristic of the propagation delay-dependent amplification as a function of at least one of an ambient situation, a driving situation, and a contamination state of at least one receiving electroacoustic transducer.

17. The driving environment sensor as recited in claim 16, further comprising an output element configured to at least one of:
(i) output a warning to the driver in the case a presence of a collision danger between the vehicle and the object is ascertained based on at least one of the measurement signals;
(ii) output a control signal to trigger an intervention in the vehicle dynamics; and
(iii) output a control signal to activate at least one passenger safety mechanism of the vehicle.
